(19) United States
(12) Patent Application Publication
(10) Pub. No.: US 2017/0227787 A1
(43) Pub. Date: Aug. 10, 2017

(54) CONNECTION STRUCTURE BETWEEN FRAME AND LEGS OF EYEGLASSES

(71) Applicant: HWA MAO OPTICAL (XIAMEN) CO., LTD., Xiamen City, Fujian Province (CN)

(72) Inventor: Tsung-wen Chen, Taipei City (TW)

(21) Appl. No.: 15/107,834

(22) PCT Filed: Oct. 29, 2014
(86) PCT No.: PCT/CN2014/089770

§ 371 Date: Jun. 23, 2016

(51) Int. Cl. G02C 5/22; G02C 5/14

(52) U.S. Cl. CPC G02C 5/2209; G02C 5/146; G02C 5/2254; G02C 2200/22

(57) ABSTRACT

Provided is a connection structure between a frame and legs of a pair of eyeglasses. A pivoting end of a leg is formed as a rotating shaft; correspondingly a pivoting end of a frame is formed as a rotating shaft base; an upper clip, an intermediate clip, and a lower clip extend from the rotating shaft base of the frame; the intermediate clip is staggered with the upper clip and the lower clip, the rotating shaft of the leg is clamped between the intermediate clip, the upper clip and the lower clip, and the rotating shaft of the leg rotates between the intermediate clip, the upper clip and the lower clip, enabling the leg to fold closed and open. The connection between the frame and the leg is screw-less, providing a simple structure, convenient installation, and comfortable wear.

### BACKGROUND OF THE INVENTION

1. Field of the Invention

The present invention relates to a pair of eyeglasses, and more particularly to a connection structure between a frame and legs of eyeglasses.

2. Description of the Prior Art

Normally, a conventional connecting structure of a frame and a leg is a hinge connecting structure. Through the hinge, the leg is pivotally connected to the frame, so that the leg can be folded or unfolded through the hinge. However, it has the following drawbacks in use.

1. For the hinge structure, both the leg and the frame are provided with hinges. It is more complicated for production. The hinge itself is more complicated, so the production and installation of the eyeglasses are minute and complicated to increase the production cost.

2. The hinge structure needs screws to lock the leg and the frame. After a period of time to fold and unfold the leg, the screws may loosen, rendering that the eyeglasses cannot be used.

3. For the hinge structure, the procedure to lock the screws is required. This increases the production cost of the eyeglasses.

Accordingly, the inventor of the present invention has devoted himself based on his many years of practical experiences to solve this problem.

### SUMMARY OF THE INVENTION

The primary objective of the present invention is to provide a connection structure between a frame and legs of eyeglasses. The structure is simile and can be installed conveniently and provides a better elasticity for wear.

In order to achieve the aforesaid objective, a connection structure between a frame and legs of eyeglasses is provided. A pivoting end of a leg is formed with a rotating shaft. A pivoting end of a frame is formed with a rotating shaft base. The rotating shaft base of the frame has an upper clip, an intermediate clip, and a lower clip extending therefrom. The intermediate clip is staggered with the upper clip and the lower clip. The rotating shaft of the leg is clamped between the intermediate clip, the upper clip, and the lower clip. The rotating shaft of the leg rotates between the intermediate clip, the upper clip, and the lower clip so as to fold or unfold the leg.

Preferably, the intermediate clip is staggered with the upper clip and the lower clip. The upper clip and the lower clip extend toward the inner side of the frame, and the intermediate clip extends toward the outer side of the frame.

Preferably, the rotating shaft of the leg is composed of an upper turning portion, an intermediate turning portion, and a lower turning portion. The rotating shaft of the leg is clamped between the intermediate clip, the upper clip, and the lower clip. The intermediate clip is adapted to hold against the outer side of the rotating shaft of the leg, and the upper clip and the lower clip are adapted to hold against the outer side of the rotating shaft of the leg.

Preferably, the upper clip and the lower clip are formed with square bent portions, and the upper turning portion and the lower turning portion of the rotating shaft of the leg are in a square shape.

Preferably, the intermediate clip is formed with a square bent portion, and the intermediate turning portion of the rotating shaft of the leg is in a square shape.

Preferably, the upper clip and the lower clip are formed with curved bent portions, and the upper turning portion and the lower turning portion of the rotating shaft of the leg are in a circle shape.

Preferably, the intermediate clip is formed with a curved bent portion, and the intermediate turning portion of the rotating shaft of the leg is in a circle shape.

Preferably, the intermediate turning portion of the rotating shaft of the leg is a recess, and the intermediate clip is engaged in the recess.

Preferably, the upper clip and the lower clip are formed with stop portions at free ends thereof. When the leg is unfolded, the stop portions of the upper clip and the lower clip hold against the outer side of the leg.

Preferably, the intermediate turning portion of the rotating shaft of the leg is connected with the leg. A receiving space is formed between the upper turning portion and the leg as well as between the lower turning portion and the leg for receiving the upper clip and the lower clip.

The rotating shaft base of the frame has the upper clip, the intermediate clip, and the lower clip extending therefrom. The intermediate clip is staggered with the upper clip and the lower clip. The rotating shaft of the leg is clamped between the intermediate clip, the upper clip, and the lower clip. The rotating shaft of the leg rotates between the intermediate clip, the upper clip, and the lower clip so as to fold or unfold the leg. Thus, the present invention has the following advantages:

1. Through the cooperation between the rotating shaft of the leg and the rotating shaft base of the frame, the leg can be folded or unfolded. The connection of the frame and the leg don't need screws. It is convenient for installation. By using the elasticity of the upper clip, and the intermediate clip, and the lower clip, the extent of the leg to be unfolded can be adjusted for comfortable wear.

2. Through the cooperation between the rotating shaft of the leg and the rotating shaft base of the frame, the leg can be folded or unfolded. The structure is simpler so as to save the production cost, and it is convenient for installation.

3. Through the cooperation between the rotating shaft of the leg and the rotating shaft base of the frame, the leg can be folded or unfolded. There is no need for the procedure to lock the screw, so the production and installation cost of the eyeglasses can be reduced.

### BRIEF DESCRIPTION OF THE DRAWINGS

FIG. 1 is a perspective view according to a preferred embodiment of the present invention;

FIG. 2 is a partial enlarged view according to the preferred embodiment of the present invention; and

FIG. 3 is an exploded view according to the preferred embodiment of the present invention.

### DETAILED DESCRIPTION OF THE PREFERRED EMBODIMENTS

Embodiments of the present invention will now be described, by way of example only, with reference to the accompanying drawings.

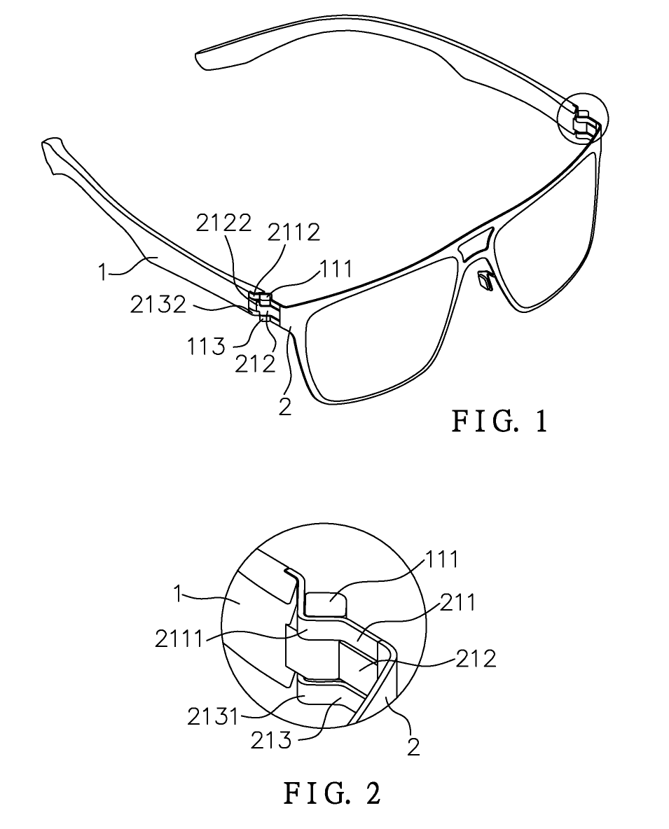

As shown in FIG. 1 to FIG. 3, the present invention discloses a connection structure between a frame and legs of eyeglasses. A pivoting end of a leg 1 is formed with a rotating shaft 11. A pivoting end of a frame 2 is formed with a rotating shaft base 21. The rotating shaft base 21 of the frame 2 has an upper clip 211, an intermediate clip 212, and a lower clip 213 extending therefrom. The intermediate clip 212 is staggered with the upper clip 211 and the lower clip 213. The rotating shaft 11 of the leg 1 is clamped between the intermediate clip 212, the upper clip 211, and the lower clip 213. The rotating shaft 11 of the leg 1 rotates between the intermediate clip 212, the upper clip 211, and the lower clip 213 so as to fold or unfold the leg 1. The present invention has a simple structure and can be installed conveniently.

The aforesaid upper, middle, and lower orientations use a vertical direction as a reference when the user wears the eyeglasses. The lower position is defined as “lower” and the upper position is defined as “upper”, namely, the position approaching the bridge of the nose is defined as “lower”, the position away from the bridge of the nose is defined as “upper”, and the position between both is defined as “middle”.

The intermediate clip 212 is staggered with the upper clip 211 and the lower clip 213, namely, the upper clip 211 and the lower clip 213 extend toward the inner side of the frame 2, and the intermediate clip 212 extends toward the outer side of the frame 2. The side toward the user's face is the inner side, and the other side is the outer side.

The rotating shaft 11 of the leg 1 is composed of an upper turning portion 111, an intermediate turning portion 112, and a lower turning portion 113. The rotating shaft 11 of the leg 1 is clamped between the intermediate clip 212, the upper clip 211, and the lower clip 213. The intermediate clip 212 is adapted to hold against the outer side of the rotating shaft 11 of the leg 1, and the upper clip 211 and the lower clip 213 are adapted to hold against the outer side of the rotating shaft 11 of the leg 1. The side toward the user's face is the inner side, and the other side is the outer side.

In general, the frame 2 is a metallic frame. The upper clip 211, the intermediate clip 212, and the lower clip 213 extending from the rotating shaft base 21 are also metallic parts, so that the rotating shaft 11 of the leg 1 is clamped between the intermediate clip 212, the upper clip 211, and the lower clip 213 to provide a better elasticity.

The upper clip 211, the intermediate clip 212, and the lower clip 213 are formed with curved bent portions 2111, 2121, 2131. The upper turning portion 111, the intermediate turning portion 112, and the lower turning portion 113 of the rotating shaft 11 of the leg 1 are in a circle shape accordingly, such that the rotating shaft 11 of the leg 1 can be turned between the intermediate clip 212, the upper clip 211, and the lower clip 213 smoothly.

Preferably, the upper clip 211, the intermediate clip 212, and the lower clip 213 are formed with square bent portions 2111, 2121, 2131. The upper turning portion 111, the intermediate turning portion 112, and the lower turning portion 113 of the rotating shaft 11 of the leg 1 are in a square shape accordingly, such that a square accommodation space is formed between the intermediate clip 212, the upper clip 211, and the lower clip 213. The rotating shaft 11 of the leg 1 is turned in the square accommodation space formed between the intermediate clip 212, the upper clip 211, and the lower clip 213. When the leg 1 is folded, the rotating shaft 11 is positioned through the square accommodation space. When the leg 1 is unfolded, the square rotating shaft 11 is turned 90 degrees and then positioned through the square accommodation space. Through this structure, the leg 1 is folded and unfolded more conveniently and easily. The structure is simple.

In this embodiment, the intermediate turning portion 112 of the rotating shaft 11 of the leg 1 is a recess. The intermediate clip 212 is engaged in the recess. The structure of the present invention can limit the slide of the rotating shaft 11 of the leg 1, namely, the rotating shaft 11 of the leg 1 can be further positioned.

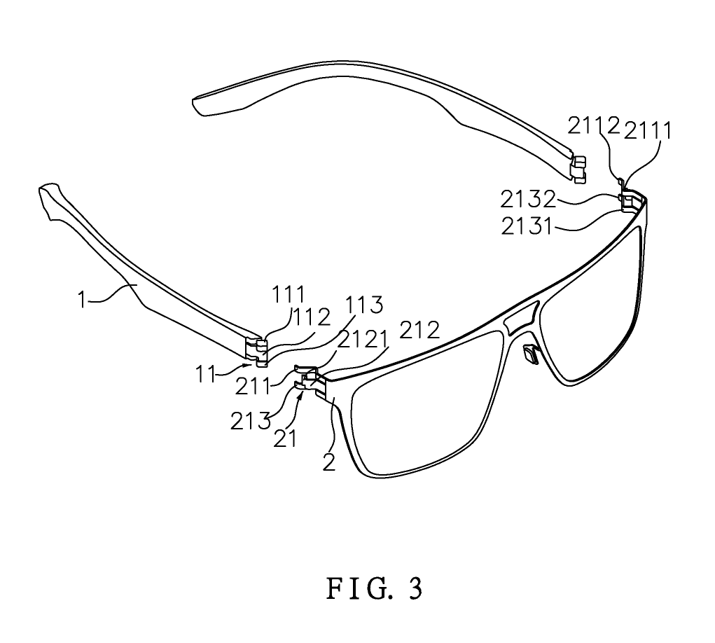

The upper clip 211 and the lower clip 213 are formed with stop portions 2112, 2132 at free ends thereof. As shown in FIG. 3, when the leg 1 is unfolded, the stop portions 2112, 2132 of the upper clip 211 and the lower clip 213 hold against the outer side of the leg 1. The side toward the user's face is the inner side, and the other side is the outer side. As shown in FIG. 1, the stop portions 2112, 2132 are adapted to limit the extent of the leg 1 to be unfolded. Normally, the leg 1 is substantially perpendicular to the frame 2. The stop portions 2112, 2132 not only limit the extent of the leg 1 to be unfolded but also enhance the elasticity of the leg 1, in particular, for the metallic frame 2.

The intermediate clip 212 may be formed with a stop portion 2122 at a free end thereof. When the leg 1 is unfolded, the stop portion 2122 of the intermediate clip 212 holds against the outer side of the leg 1 to further enhance the elasticity of the leg 1.

The intermediate turning portion 112 of the rotating shaft 11 of the leg 1 is connected with the leg 1. A receiving space is formed between the upper turning portion 111 and the leg 1 as well as between the lower turning portion 113 and the leg 1 for receiving the upper clip 211 and the lower clip 213. This structure makes the upper clip 211 and the lower clip 213 more compact and simple.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A connection structure between a frame and a leg of eyeglasses, a pivoting end of the leg being formed with a rotating shaft, a pivoting end of the frame being formed with a rotating shaft base, the rotating shaft base of the frame having an upper clip, an intermediate clip, and a lower clip extending therefrom, the intermediate clip being staggered with the upper clip and the lower clip, the rotating shaft of the leg being clamped between the intermediate clip, the upper clip, and the lower clip, the rotating shaft of the leg rotating between the intermediate clip, the upper clip, and the lower clip so as to fold or unfold the leg.

2. The connection structure between a frame and a leg of eyeglasses as claimed in claim 1, wherein the intermediate clip is staggered with the upper clip and the lower clip, the upper clip and the lower clip extend toward an inner side of the frame, and the intermediate clip extends toward an outer side of the frame.

3. The connection structure between a frame and a leg of eyeglasses as claimed in claim 1, wherein the rotating shaft of the leg is composed of an upper turning portion, an intermediate turning portion, and a lower turning portion, the rotating shaft of the leg is clamped between the intermediate clip, the upper clip, and the lower clip, the intermediate clip is adapted to hold against an outer side of the rotating shaft of the leg, and the upper clip and the lower clip are adapted to hold against an outer side of the rotating shaft of the leg.

4. The connection structure between a frame and a leg of eyeglasses as claimed in claim 3, wherein the upper clip and the lower clip are formed with square bent portions, and the upper turning portion and the lower turning portion of the rotating shaft of the leg are in a square shape.

5. The connection structure between a frame and a leg of eyeglasses as claimed in claim 3, wherein the intermediate clip is formed with a square bent portion, and the intermediate turning portion of the rotating shaft of the leg is in a square shape.

6. The connection structure between a frame and a leg of eyeglasses as claimed in claim 3, wherein the upper clip and the lower clip are formed with curved bent portions, and the upper turning portion and the lower turning portion of the rotating shaft of the leg are in a circle shape.

7. The connection structure between a frame and a leg of eyeglasses as claimed in claim 3, wherein the intermediate clip is formed with a curved bent portion, and the intermediate turning portion of the rotating shaft of the leg is in a circle shape.

8. The connection structure between a frame and a leg of eyeglasses as claimed in claim 3, wherein the intermediate turning portion of the rotating shaft of the leg is a recess, and the intermediate clip is engaged in the recess.

9. The connection structure between a frame and a leg of eyeglasses as claimed in claim 1, wherein the upper clip and the lower clip are formed with stop portions at free ends thereof, when the leg is unfolded, the stop portions of the upper clip and the lower clip hold against an outer side of the leg.

10. The a connection structure between a frame and a leg of eyeglasses as claimed in claim 3, wherein the intermediate turning portion of the rotating shaft of the leg is connected with the leg, and a receiving space is formed between the upper turning portion and the leg as well as between the lower turning portion and the leg for receiving the upper clip and the lower clip.
